(19) United States
(12) Patent Application Publication
(10) Pub. No.: US 2025/0246052 A1
(43) Pub. Date: Jul. 31, 2025

(54) VALUABLE MEDIUM HANDLING APPARATUS, AND VALUABLE MEDIUM HANDLING METHOD

(71) Applicant: Glory Ltd., Himeji (JP)

(72) Inventor: Koutarou OOI, Himeji (JP)

(73) Assignee: Glory Ltd., Himeji (JP)

(21) Appl. No.: 19/040,906

(22) Filed: Jan. 30, 2025

(30) Foreign Application Priority Data
Jan. 31, 2024 (JP) 2024-012833

(51) Int. Cl. G07G 1/00; G07F 19/00

(52) U.S. Cl. CPC G07G 1/0036; G07F 19/202

(57) ABSTRACT

A valuable medium handling apparatus and the like capable of allowing a deposit operator to perform depositing through an easy-to-understand operation are provided. A depositing machine is a valuable medium handling apparatus for depositing proceeds obtained from sales commodities or provision of services by a deposit source, and includes an acquisition unit configured to acquire a type of the deposit source, and a determination unit configured to determine a handling date of proceeds to be deposited, according to the type of the deposit source acquired by the acquisition unit.

### CROSS-REFERENCE TO RELATED APPLICATION

This application is based on and claims priority under 35 USC § 119 to Japanese Patent Application No. 2024-012833 filed on Jan. 31, 2024, the disclosure of which is incorporated herein by reference in its entirety.

### BACKGROUND

The present invention relates to a valuable medium handling apparatus, and a valuable medium handling method.

A management device for a proceeds settlement system that settles proceeds from registers in retail stores including company-operated stores and tenant stores has been known. The management device for the proceeds settlement system includes: a registration memory; a register number input means; an amount counting means; a journal printing means; and a control means as follows. That is, after the settlement, the control means determines whether an inputted register number belongs to a company-operated store or a tenant store with reference to data registered in the registration memory. When the register number belongs to a tenant store, the control means activates at least the bankbook printing means to print a settlement amount on the bankbook. When the register number belongs to a company-operated store, the control means activates the journal printing means and does not activate the bankbook printing means.

A valuable medium handling apparatus that is used in a complex retail store where a store directly operated by a parent company and a tenant store operated by another company participate, and allows operators of both stores to deposit sales proceeds from each register through an efficient operation that prevents the operators from making erroneous inputs has been known. That is, the valuable medium handling apparatus manages sales performance information indicating sales performance of each register in charge of settlement for commodities, and stores therein valuable media obtained through payment at the register. The valuable medium handling apparatus includes: an information acquisition means; a register type specifying means; and a reception means. The reception means switches an interface for receiving an input of the sales performance information according to the type of the register specified by the register type specifying means.

### SUMMARY

The present disclosure is a valuable medium handling apparatus for depositing proceeds obtained from sales of commodities or provision of services by a deposit source, and includes: an acquisition unit configured to acquire a type of the deposit source; and a determination unit configured to determine a handling date of proceeds to be deposited, according to the type of the deposit source acquired by the acquisition unit.

From another standpoint, the present disclosure is a valuable medium handling method including: acquiring a type of a deposit source; and determining a handling date of proceeds obtained from sales of commodities or provision of services, according to the type of the deposit source acquired by the acquisition function.

According to the present disclosure, a deposit operator is allowed to perform depositing through an easy-to-understand operation.

### BRIEF DESCRIPTION OF THE DRAWINGS

FIG. 1 is a diagram showing an example of a schematic structure of a money handling system according to an embodiment;

FIG. 2 is a diagram showing an example of schematic structures of a depositing machine and a server;

FIGS. 3A and 3B are diagrams showing an example of information stored in a memory of the server;

FIGS. 4A and 4B show an example of a diagram illustrating the relationship between the depositing mode, the proceeds source type, the depositing operation time, and the proceeds handling date;

FIG. 5 shows an example of a diagram illustrating the relationship between the depositing mode, the type of proceeds source, the time of depositing operation, and the date of proceeds handling;

FIG. 6 is a diagram showing an example of a screen displayed on an operation/display unit;

FIGS. 7A and 7B are diagrams showing an example of a screen displayed on the operation/display unit;

FIG. 8 is a diagram showing an example of a screen displayed on the operation/display unit;

FIGS. 9A and 9B are diagrams showing an example of a screen displayed on the operation/display unit; and

FIG. 10 is a flowchart showing an example of a depositing process performed when a controller of the depositing machine is in the first mode.

### DESCRIPTION OF THE PREFERRED EMBODIMENTS

Hereinafter, an embodiment will be described in detail with reference to the accompanying drawings.

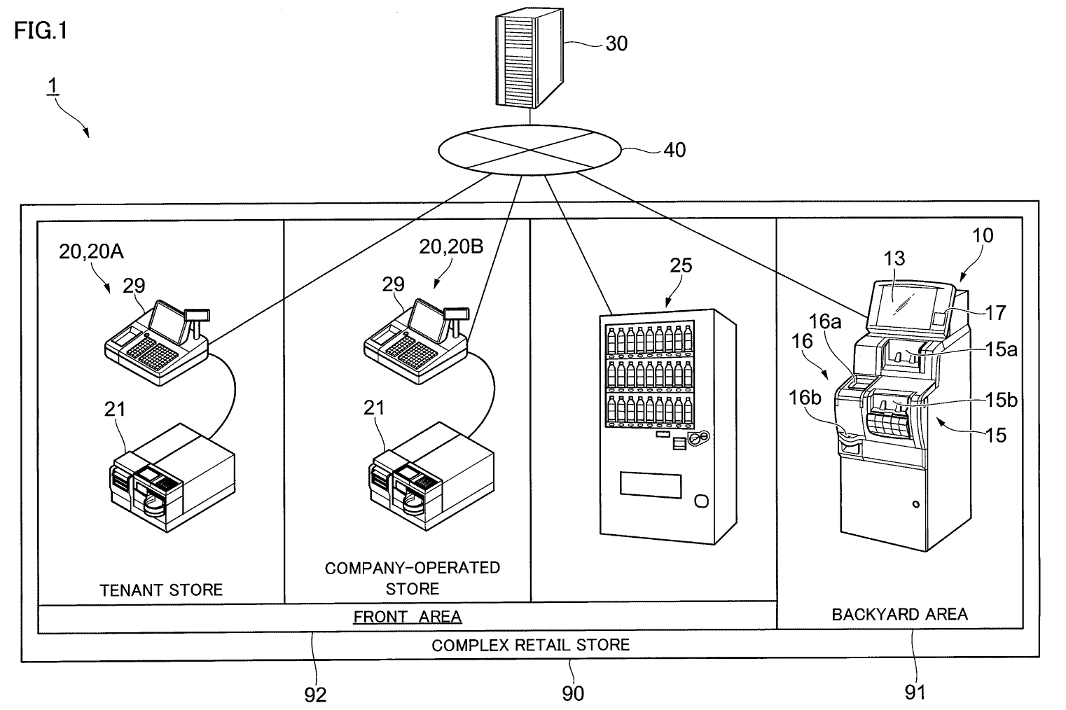

FIG. 1 is a diagram showing an example of a schematic structure of a money handling system 1 (hereinafter, sometimes referred to simply as “system 1”) according to the embodiment.

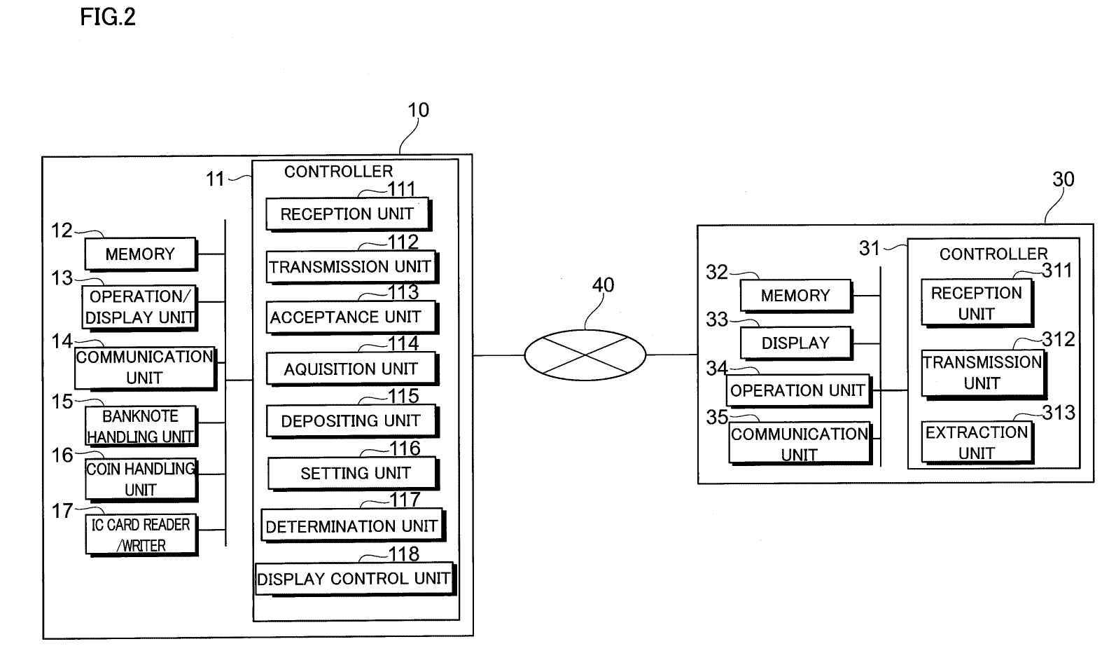

FIG. 2 is a diagram showing an example of schematic structures of a depositing machine 10 and a server 30.

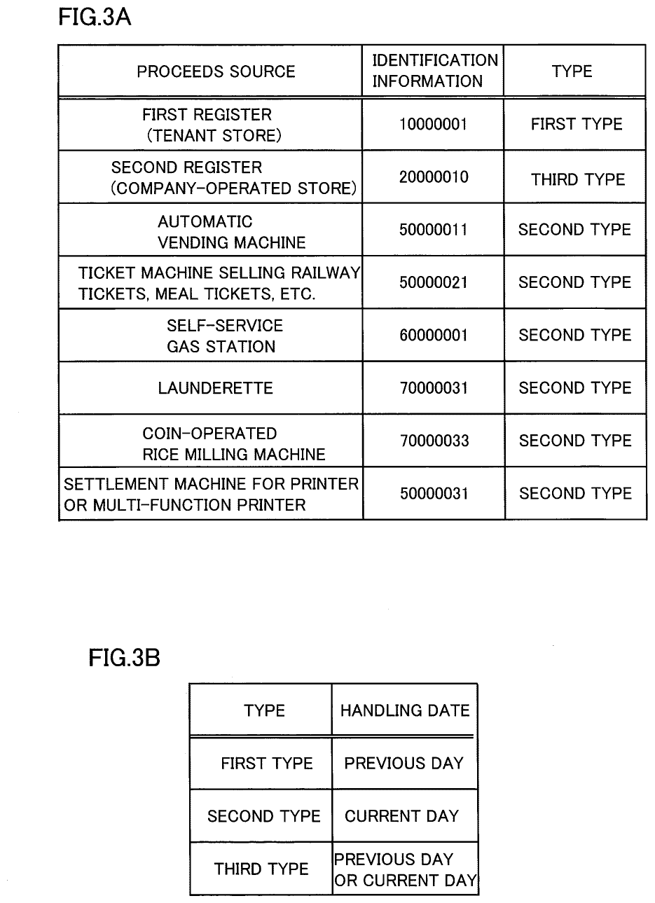

FIGS. 3A and 3B are diagrams showing an example of information stored in a memory 32 of the server 30.

In a complex retail store 90 where a store directly operated by a parent company and a tenant store operated by another company participate, for example, the system 1 includes: a depositing machine 10 installed in a backyard area 91 where customers are prohibited from entering; registers 20 (change machine 21 and POS register 29) installed in a front area 92 where customers are allowed to enter; and an automatic vending machine 25 installed in the front area 92. The registers 20 include a first register 20A installed in the tenant store, and a second register 20B installed in the company-operated store.

The system 1 further includes a server 30 capable of communicating with the depositing machine 10 and the registers 20 via a network 40. The server 30 may be installed in the complex retail store 90 where the depositing machine 10 and the registers 20 are installed, or may be installed outside the complex retail store 90. The network 40 is not particularly limited as long as it is a communication network used for inter-device data communication. Examples of the network 40 include the Internet, a wide area network (WAN), and a local area network (LAN). Communication lines used for data communication may be wired or wireless, and both of them may be used together. The wireless LAN may be, for example, WiFi (registered trademark).

In the complex retail store 90, a deposit operator, who performs an operation of depositing proceeds stored in the register 20, takes out the valuable media such as cash and vouchers stored in the register 20, for example, and deposits the taken-out valuable media into the depositing machine 10 installed in the backyard area 91. In addition, a deposit operator who performs an operation of depositing proceeds stored in the automatic vending machine 25, a ticket machine, or the like, takes out the cash stored in the automatic vending machine 25, for example, and deposits the taken-out cash into the depositing machine 10 installed in the backyard area 91.

The proceeds in the register 20 are money obtained through the register 20, out of money obtained through transaction of commodities in the store where the register 20 is installed, or money obtained by providing services in the store where the register 20 is installed. The proceeds in the automatic vending machine 25 or the ticket machine are money obtained through transaction of commodities in the machines (tickets in the ticket machine).

The system 1 enables the deposit operator to perform depositing through an easy-to-understand operation. Hereinafter, the depositing machine 10 and the server 30 constituting the system 1 will be described in detail.

### (Server 30)

The server 30 includes a controller 31 that controls the entire device, a memory 32 used to store data and the like, a display 33 used to display operation reception screens and images, an operation unit 34 that receives an input operation of the user, and a communication unit 35 used for communication with the depositing machine 10, the registers 20, and the like.

Examples of the memory 32 include a semiconductor memory, a hard disk drive (HDD), and the like. As shown in FIG. 3A, the memory 32 stores identification information and a type in association with each of proceeds sources including the registers 20, the automatic vending machine 25, and the like. As for the type, a first type, a second type, and a third type are provided in the present embodiment. The first register 20A installed in the tenant store is set as the first type, the automatic vending machine 25 is set as the second type, and the second register 20B installed in the company-operated store is set as the third type. In addition, a ticket machine selling railway tickets, meal tickets, etc., a self-service gas station, a launderette, a coin-operated rice milling machine, a settlement machine for a printer or a multi-function printer, and the like are set as the second type similarly to the automatic vending machine 25. In addition, as shown in FIG. 3B, the memory 32 stores the relationship between the type of proceeds source and the proceeds handling date in the case where a depositing mode described later is a first mode.

The controller 31 is implemented by a central processing unit (CPU), a read only memory (ROM), and a random access memory (RAM), for example.

The controller 31 includes a reception unit 311 that receives information from the depositing machine 10 and the registers 20, a transmission unit 312 that transmits information to the depositing machine 10, and an extraction unit 313 that, upon receiving an inquiry about the type of the proceeds source from the depositing machine 10, extracts the type of the proceeds source.

Upon receiving the inquiry about the type of the proceeds source (e.g., the first register 20A) from the depositing machine 10, the extraction unit 313 extracts the type that is stored in the memory 32 in association with the identification information of this proceeds source. The type of the proceeds source extracted by the extraction unit 313 is transmitted to the depositing machine 10 by the transmission unit 312.

### (Depositing Machine 10)

The depositing machine 10 includes a controller 11 that controls the entire machine, and a memory 12 used to store data and the like. The depositing machine 10 further includes: an operation/display unit 13 capable of displaying operation reception screens and images, and receiving an input operation performed by a clerk; and a communication unit 14 such as a communication interface that is used for communication with the server 30. The depositing machine 10 further includes, inside a casing having a substantially rectangular parallelepiped shape, a banknote handling unit 15 that performs a banknote depositing process, a coin handling unit 16 that performs a coin depositing process, and an IC card reader/writer 17.

The memory 12 may be, for example, a storage device such as a semiconductor memory.

The operation/display unit 13 may be, for example, a touch panel obtained by combining a display device for displaying still images, moving images, and the like, with a position input device. On the operation/display unit 13, an operation screen for an operation of the clerk, and information on the inventory amount of money are displayed. The operation/display unit 13 allows the clerk to input various instructions into the controller 11 by touching operation buttons on the operation screen with a finger.

The banknote handling unit 15 includes: a banknote inlet 15a through which banknotes and vouchers are inserted into the depositing machine 10; and a banknote reject port 15b through which banknotes and vouchers, which are not determined as genuine notes and genuine vouchers as a result of authenticity determination performed on the banknotes and vouchers inserted in the banknote inlet 15a, are discharged.

The coin handling unit 16 includes: a coin inlet 16a through which coins are inserted into the depositing machine 10; and a coin reject port 16b through which coins, which are not determined as genuine coins as a result of authenticity determination performed on the coins inserted in the coin inlet 16a, are rejected.

The IC card reader/writer 17 is an input/output unit capable of reading and updating the content stored in an IC card such as a register card or an employee card when the IC card is held up to the IC card reader/writer 17.

The controller 11 is implemented by a CPU, a ROM, and a RAM, for example.

The controller 11 includes a reception unit 111 that receives information from the server 30, a transmission unit 112 that transmits information to the server 30, an acceptance unit 113 that accepts a depositing process, and an acquisition unit 114 that acquires the type of a proceeds source. The controller 11 further includes a depositing unit 115 that performs a proceeds depositing process, a setting unit 116 that sets a depositing mode regarding the depositing process, a determination unit 117 that determines the proceeds handling date, and a display control unit 118 that controls the operation/display unit 13.

When the clerk touches a predetermined operation button displayed on the operation/display unit 13, the acceptance unit 113 accepts a predetermined process to be performed. For example, when the clerk touches an operation button for depositing on a menu screen displayed on the operation/display unit 13, the acceptance unit 113 accepts a depositing process to be performed. The acceptance unit 113 accepts, together with the request for the depositing process, identification information of a proceeds source (e.g., the first register 20A) of the proceeds to be deposited through the depositing process.

The acquisition unit 114 acquires the type of the proceeds source of the proceeds to be deposited by the depositing process accepted by the acceptance unit 113. For example, the acquisition unit 114 acquires the type of the proceeds source included in the information that the reception unit 111 has received from the server 30.

The depositing unit 115 performs the depositing process by controlling the banknote handling unit 15 and/or the coin handling unit 16. The depositing process performed by the depositing unit 115 will be described in detail later.

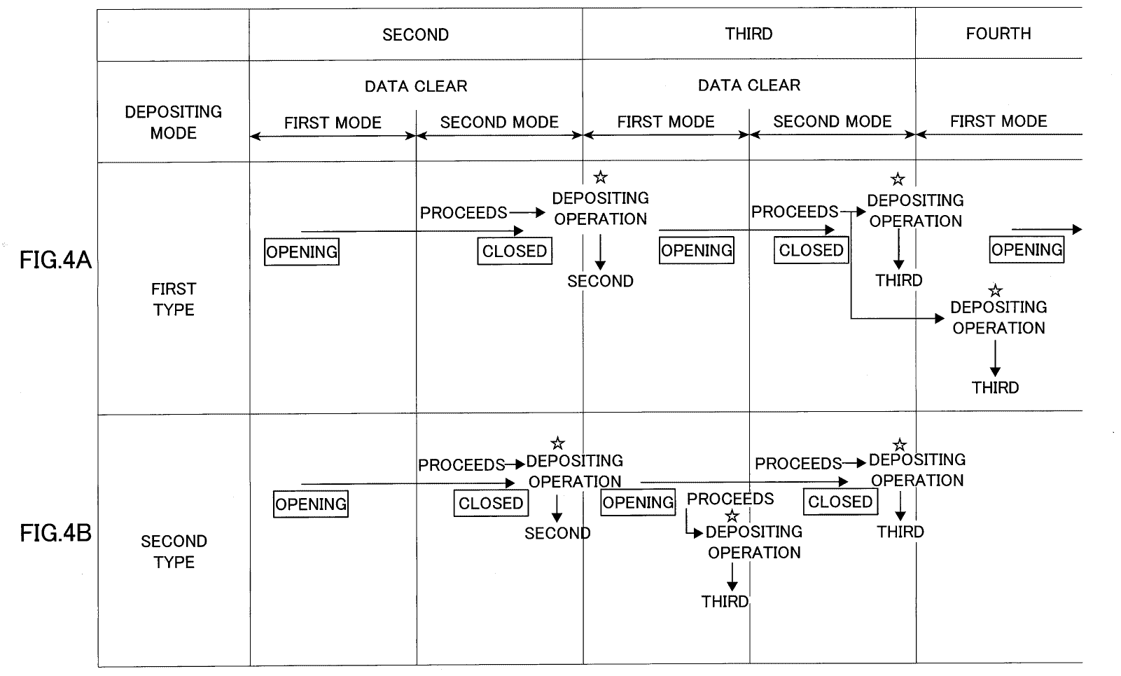

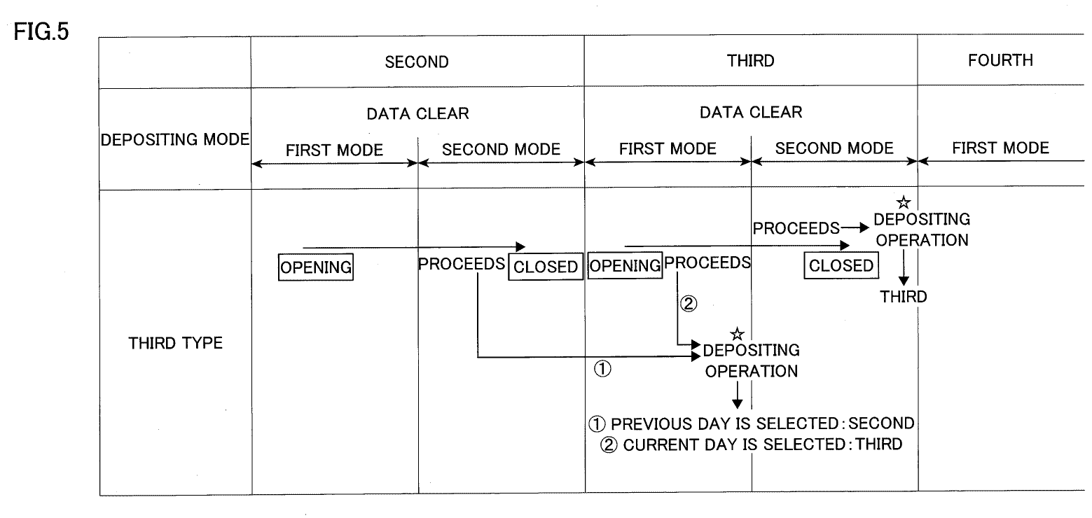

FIGS. 4A, 4B and FIG. 5 show an example of diagrams illustrating the relationship between the depositing mode, the proceeds source type, the depositing operation time, and the proceeds handling date.

The setting unit 116 sets depositing modes according to time periods. Here, with the depositing machine 10, an administrator performs closing and totalization every day at a predetermined time (e.g., 12 pm), and clears data. Every day, the setting unit 116 sets a depositing mode in a time period before the data clear to the first mode, and sets the depositing mode in a time period after the data clear to the second mode. That is, the setting unit 116 sets the depositing mode in a period from 12 am to the data clear to the first mode, and sets the depositing mode in a period from the data clear to when the date changes to the second mode.

The determination unit 117 determines the proceeds handling date by using the depositing mode set by the setting unit 116 and the type of the proceeds source.

The determination unit 117 determines that the handling date of the proceeds in the first-type proceeds source is the previous day if the depositing operation is performed when the depositing mode is the first mode, and determines that the handling date is the current day if the depositing operation is performed when the depositing mode is the second mode. For example, as shown in FIG. 4A, the determination unit 117 determines that the handling date of the proceeds in the first-type proceeds source is the 2nd day if the depositing operation is performed in the first mode on the 3rd day, and determines that the handling date is the 3rd day if the depositing operation is performed in the second mode on the 3rd day.

The determination unit 117 determines that the handling date of the proceeds in the second-type proceeds source is the current day regardless of whether the depositing operation is performed in the first mode or the second mode. For example, as shown in FIG. 4B, the determination unit 117 determines that the handling date of the proceeds in the second-type proceeds source is the 3rd day in both cases where the depositing operation is performed in the first mode on the 3rd day and where the depositing operation is performed in the second mode on the 3rd day.

The determination unit 117 determines that the handling date of the proceeds in the third type proceeds source is the day selected by the deposit operator from the previous day and the current day if the depositing operation is performed in the first mode, and determines that the handling date is the current day if the depositing operation is performed in the second mode. For example, as shown in FIG. 5, in the case where the depositing operation is performed in the first mode on the 3rd day, the determination unit 117 determines that the proceeds handling date is the 2nd day if the 2nd day, which is the previous day, is selected, and determines that the proceeds handling date is the 3rd day if the 3rd day, which is the current day, is selected. Meanwhile, the determination unit 117 determines that the proceeds handling date is the 3rd day if the depositing operation is performed in the second mode on the 3rd day.

In other words, the second mode is a mode in which the determination unit 117 determines that the handling date of the proceeds having been subjected to the depositing operation is the current day.

The first mode is a mode in which, when the type of the proceeds source is the first type or the second type, the determination unit 117 determines the proceeds handling date according to the type. That is, the determination unit 117 determines that the proceeds handling date is the previous day if the type is the first type, and determines that the proceeds handling date is the current day if the type is the second type.

Furthermore, the first mode is a mode in which, when the type of the proceeds source is the third type, the determination unit 117 is allowed to determine that the proceeds handling date is the day selected by the deposit operator from the previous day and the current day.

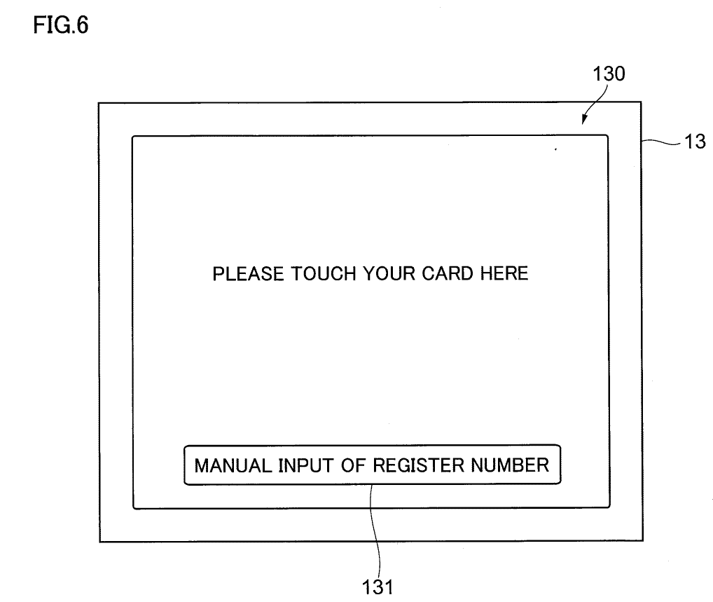

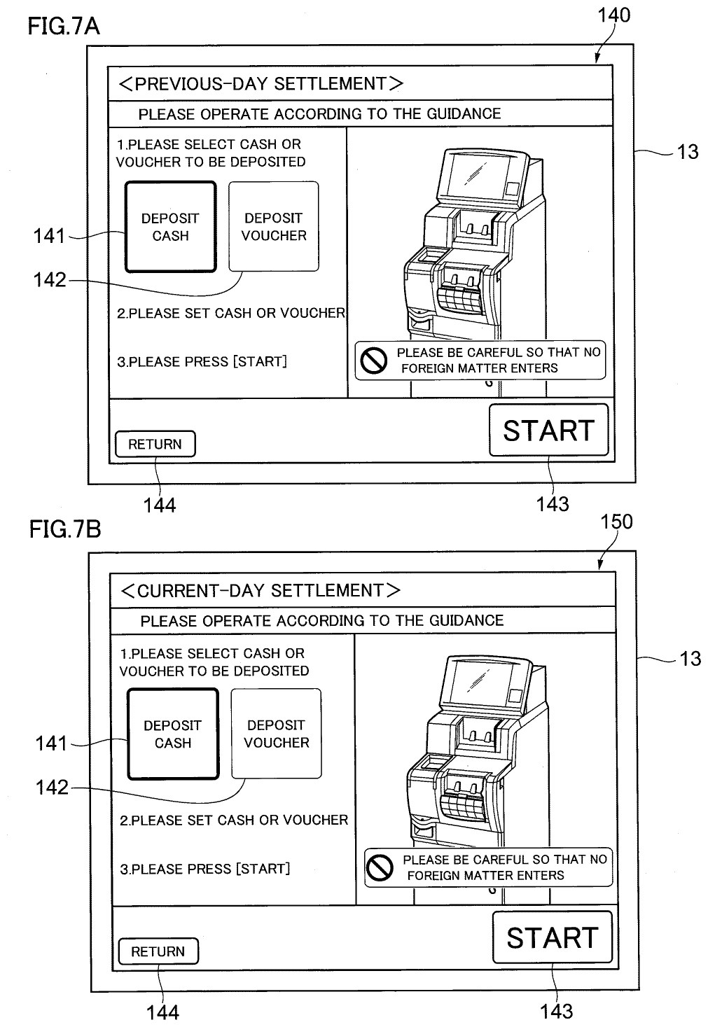

FIG. 6, FIGS. 7A and 7B, FIG. 8, and FIGS. 9A and 9B are diagrams each showing an example of a screen displayed on the operation/display unit 13.

When depositing is selected from a menu screen displayed on the operation/display unit 13, the display control unit 118 causes the operation/display unit 13 to display a request screen 130 as shown in FIG. 6. The display control unit 118 causes the operation/display unit 13 to display, on the request screen 130, the text “please touch your card here” and an input button 131 on which the text “manual input of register number” is described. Note that the depositing operation is started when depositing has been selected from the menu screen displayed on the operation/display unit 13, e.g., when a button with the text “deposit” displayed on the menu screen has been pressed.

If the input button 131 is pressed, the display control unit 118 urges the deposit operator to manually input the register number with a register number input screen being displayed. The register number is a number for identifying a proceeds source such as the register 20 or the automatic vending machine 25, and may be the same as the identification information shown in FIGS. 3A and 3B.

If the determination unit 117 determines that the handling date of the proceeds having been subjected to the depositing operation is the previous day, the display control unit 118 causes the operation/display unit 13 to display a previous-day deposit screen 140 as shown in FIG. 7A Although the previous-day deposit screen 140 shown in FIG. 7A has the text “previous-day settlement”, the display control unit 118 may cause the operation/display unit 13 to display a specific date (e.g., October 2nd) as “the previous day”.

If the determination unit 117 determines that the handling date of the proceeds having been subjected to the depositing operation is the current day, the display control unit 118 causes the operation/display unit 13 to display a current-day deposit screen 150 as shown in FIG. 7B. Although the current-day deposit screen 150 shown in FIG. 7B has the text “current-day settlement”, the display control unit 118 may cause the operation/display unit 13 to display a specific date (e.g., October 3rd) as the “current day”.

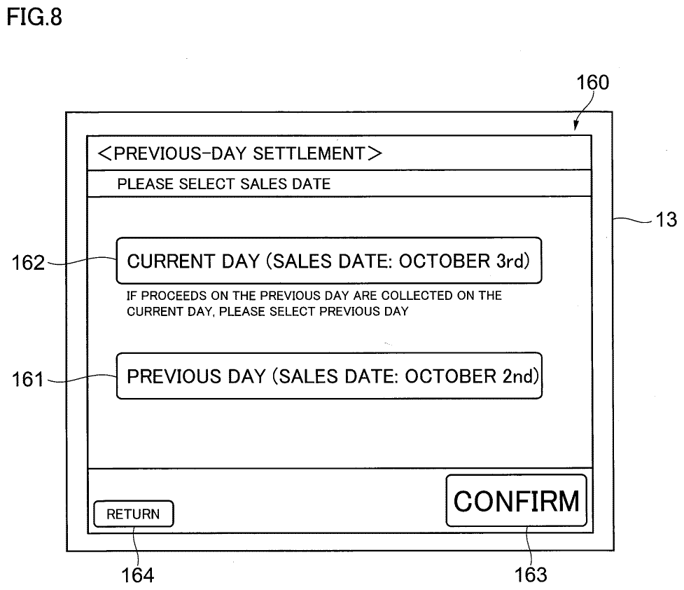

If the deposit operator is allowed to select the handling date of the proceeds having been subjected to the depositing, the display control unit 118 causes the operation/display unit 13 to display a selection screen 160 as shown in FIG. 8 The display control unit 118 causes the operation/display unit 13 to display, on the selection screen 160, a previous-day button 161 on which the text “previous day” are described, and a current-day button 162 on which the text “current day” are described. Furthermore, the display control unit 118 causes the operation/display unit 13 to display, on the selection screen 160, a confirmation button 163 on which the text “confirm” is described, and a return button 164 on which the text “return” is described.

If the confirmation button 163 is pressed with the previous-day button 161 being pressed and highlighted, the display control unit 118 causes the operation/display unit 13 to display the previous-day deposit screen 140 as shown in FIG. 7A. If the confirmation button 163 is pressed with the current-day button 162 being pressed and highlighted, the display control unit 118 causes the operation/display unit 13 to display the current-day deposit screen 150 as shown in FIG. 7B. Furthermore, if the return button 164 is pressed, the display control unit 118 causes the operation/display unit 13 to display the request screen 130 shown in FIG. 6.

Before causing the operation/display unit 13 to display the previous-day deposit screen 140 as shown in FIG. 7A, the display control unit 118 may cause the operation/display unit 13 to display a pop-up message or the like informing that the proceeds handling date is the previous day, and may cause the operation/display unit 13 to display the previous-day deposit screen 140 after the operator confirms that the proceeds handling date is the previous day.

Furthermore, before causing the operation/display unit 13 to display the current-day deposit screen 150 as shown in FIG. 7B, the display control unit 118 may cause the operation/display unit 13 to display a pop-up message or the like informing that the proceeds handling date is the current day, and may cause the operation/display unit 13 to display the current-day deposit screen 150 after the operator confirms that the proceeds handling date is the current day.

As shown in FIG. 7A and FIG. 7B, the display control unit 118 causes the operation/display unit 13 to display a cash button 141 on which the text “deposit cash” is described and a voucher button 142 on which the text “deposit voucher” is described, on each of the previous-day deposit screen 140 and the current-day deposit screen 150. Furthermore, the display control unit 118 causes the operation/display unit 13 to display a start button 143 on which the text “start” is described and a return button 144 on which the text “return” is described, on each of the previous-day deposit screen 140 and the current-day deposit screen 150.

If the start button 143 is pressed with either the cash button 141 or the voucher button 142 being pressed according to a message “1. Please select cash or voucher to be deposited.” displayed on the previous-day deposit screen 140 shown in FIG. 7A or the current-day deposit screen 150 shown in FIG. 7B, the depositing unit 115 starts counting of cash or vouchers. If the cash button 141 is pressed by the clerk, banknotes are inserted into the banknote inlet 15a and coins are inserted into the coin inlet 16a according to a message “2. Please set cash or vouchers.” Meanwhile, when the voucher button 142 is pressed by the clerk, vouchers are inserted in the banknote inlet 15a according to the message “2. Please set cash or vouchers”.

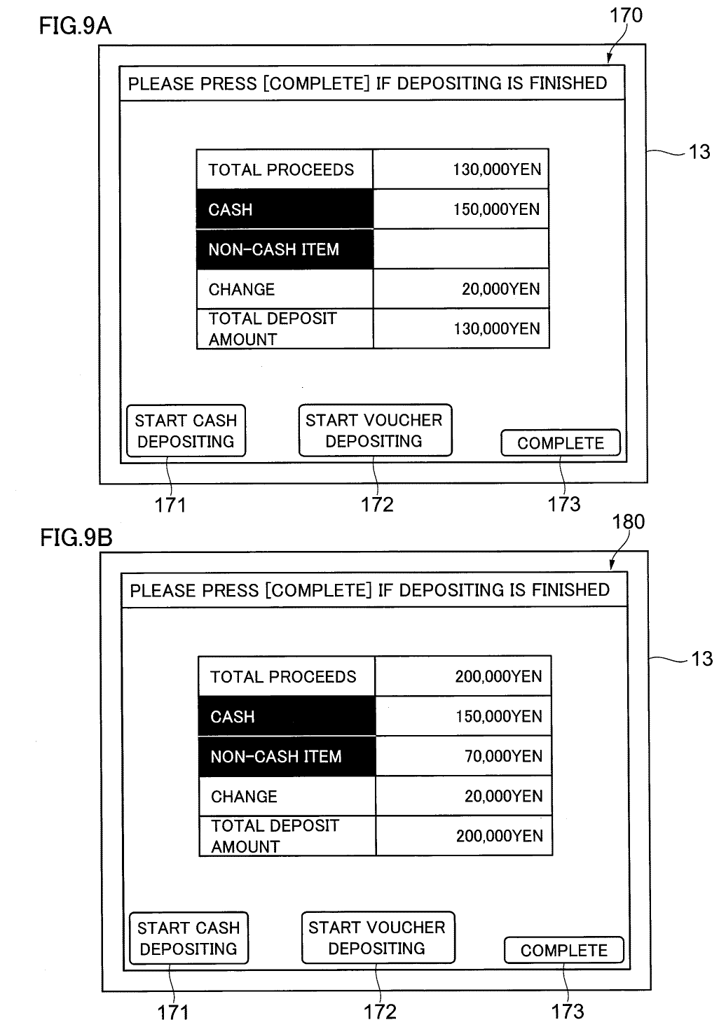

When the depositing unit 115 has finished counting of the valuable media inserted in the depositing machine 10, the display control unit 118 causes the operation/display unit 13 to display a confirmation screen 170 as shown in FIG. 9A for confirmation of the depositing content and instruction of additional depositing. The display control unit 118 displays a counting result of cash (e.g., 150,000 yen) counted by the depositing unit 115 in the field of “cash” on a table displayed on the confirmation screen 170. Furthermore, the display control unit 118 displays a subtraction amount (e.g., 130,000 yen) obtained by subtracting a change (e.g., 20,000 yen) from the cash counting result (e.g., 150,000 yen) in the fields of “total proceeds” and “total deposit amount” on the table displayed on the confirmation screen 170. Moreover, the display control unit 118 displays a cash deposit button 171 indicating “start cash depositing” for instructing additional cash depositing, and a voucher deposit button 172 indicating “start voucher depositing” for instructing voucher depositing, on a lower part of the confirmation screen 170. Moreover, the display control unit 118 displays, on the confirmation screen 170, a completion button 173 indicating “completion” to be pressed when the contents on the table have no problem and the depositing process should be completed with the contents.

With the confirmation screen 170 shown in FIG. 9A being displayed by the display control unit 118, if vouchers are set in the banknote inlet 15a and the voucher deposit button 172 is pressed, the depositing unit 115 starts counting of the vouchers.

When the depositing unit 115 has finished counting of the vouchers set in the banknote inlet 15a, the display control unit 118 causes the operation/display unit 13 to display a reflection screen 180 on which the voucher counting result is reflected as shown in FIG. 9B. FIG. 9B shows an example in which 70,000 yen as the voucher counting result is reflected in the field of “non-cash item” on the table. The voucher counting result is also added to each of the fields of “total deposit amount” and “total proceeds” on the table, so that the total becomes “200,000 yen”. The display control unit 118 displays a cash deposit button 171, a voucher deposit button 172, and a completion button 173 on the reflection screen 180, similarly to the confirmation screen 170.

The display control unit 118 highlights items (e.g., cash, non-cash item) whose values can be manually corrected on the confirmation screen 170 and the reflection screen 180.

When the field of “cash”, which is highlighted, is pressed, the display control unit 118 displays a screen for manually inputting a deposit amount of cash, thereby allowing manual input of a deposit amount of cash, separately from the cash counted by the depositing unit 115. Thus, if there is money having, for example, a high degree of damage, which will be rejected in the depositing machine 10, the clerk can manually input a monetary amount on the screen that is displayed when he/she touches the field of “cash”.

Furthermore, when the field of “non-cash item”, which is highlighted, is pressed, the display control unit 118 displays a screen for manually inputting a deposit amount of items other than cash, thereby allowing manual input of a deposit amount of items other than cash, separately from the vouchers counted by the depositing unit 115. Thus, when there is a voucher that will be rejected in the depositing machine 10, or a credit card payment or an electronic money payment having no actual items to be stored in the depositing machine 10, the clerk can manually input the amount of the voucher to be rejected or the total amount of the credit card payment or the electronic money payment on the screen displayed by touching the field of “non-cash item”.

If the completion button 173 displayed on the confirmation screen 170 or the reflection screen 180 is pressed, the depositing unit 115 completes the depositing process. That is, the depositing unit 115 performs printing on a journal and/or a bankbook to update deposit history data, stores banknotes and vouchers held in a temporary banknote storage unit into a banknote storage unit, and stores coins held in a temporary coin storage unit into a coin storage unit. The date and time when the depositing process was completed and the proceeds handling date may also be described on the journal printed by the depositing unit 115. Instead of or in addition to printing on the journal, the depositing unit 115 may display the deposit amount, the date and time when the depositing process was completed, the proceeds handling date, and the like on the operation/display unit 13.

Next, an example of a depositing process performed by the controller 11 of the depositing machine 10 will be described with reference to a flowchart.

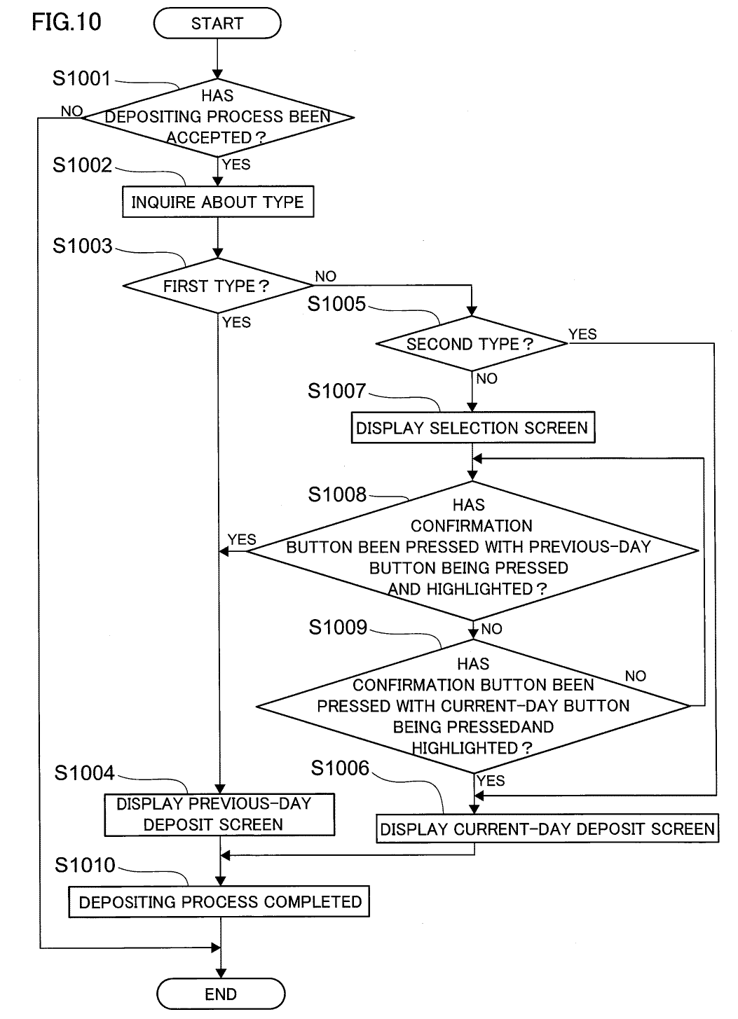

FIG. 10 is a flowchart showing an example of a depositing process performed when the controller 11 of the depositing machine 10 is in the first mode. The controller 11, in the first mode, repeatedly executes this process for each predetermined period of time (e.g., 1 millisecond).

The controller 11 determines whether or not a depositing process has been accepted (S1001). The process of S1001 includes: determining whether or not the IC card reader/writer 17 has been touched with a register card after the request screen 130 shown in FIG. 6 was displayed; determining that the acceptance unit 113 accepts the depositing process when the IC card reader/writer 17 has been touched with the register card; and determining that the acceptance unit 113 does not accept the depositing process when the IC card reader/writer 17 has not been touched with the register card. Furthermore, in the process of S1001, even when the IC card reader/writer 17 has not been touched with the register card, if the register number is inputted, it is determined that the acceptance unit 113 accepts the depositing process. When no depositing process has been accepted (NO in S1001), the controller 11 ends this process. When a depositing process has been accepted (YES in S1001), the controller 11 inquires the server 30 about the type of the proceeds source (S1002).

After the inquiry about the type of the proceeds source in S1002, the controller 11, upon acquiring the type, determines whether or not the type is the first type (S1003). When the type is the first type (YES in S1003), the controller 11 displays the previous-day deposit screen 140 (S1004). For example, in the process of S1003, when the acquisition unit 114 has acquired the type, the display control unit 118 determines whether or not the type is the first type. When the type is the first type, in the process of S1004, the display control unit 118 causes the operation/display unit 13 to display the previous-day deposit screen 140 as shown in FIG. 7A.

When the type is not the first type (NO in S1003), the controller 11 determines whether or not the type of the proceeds source is the second type (S1005). When the type is the second type (YES in S1005), the controller 11 displays the current-day deposit screen 150 (S1006). The process of S1006 is a process in which the display control unit 118 causes the operation/display unit 13 to display the current-day deposit screen 150 as shown in FIG. 7B.

When the type is not the second type (NO in S1005), the controller 11 determines that the type of the proceeds source is the third type, and displays the selection screen 160 (S1007). The process of S1007 is a process in which the display control unit 118 causes the operation/display unit 13 to display the selection screen 160 as shown in FIG. 8.

Thereafter, the controller 11 determines whether or not the confirmation button 163 has been pressed with the previous-day button 161 being pressed and highlighted (S1008). When the confirmation button 163 has been pressed with the previous-day button 161 being highlighted (YES in S1008), the controller 11 displays the previous-day deposit screen 140 (S1004). When the confirmation button 163 has not been pressed with the previous-day button 161 being highlighted (NO in S1008), the controller 11 determines whether or not the confirmation button 163 has been pressed with the current-day button 162 being pressed and highlighted (S1009). When the confirmation button 163 has been pressed with the current-day button 162 being highlighted (YES in S1009), the controller 11 displays the current-day deposit screen 150 (S1006). When the confirmation button 163 has not been pressed with the current-day button 162 being highlighted (NO in S1009), the controller 11 performs the process in S1008 and subsequent processes.

After displaying the previous-day deposit screen 140 in S1004 or displaying the current-day deposit screen 150 in S1006, the controller 11 completes the depositing process according to an operation performed on the screen by the deposit operator (S1010). The process in S1010 is a process in which the screen that the display control unit 118 causes the operation/display unit 13 to display is shifted, and the depositing unit 115 performs counting and storage of cash or vouchers.

As described above, when the depositing mode is the first mode and the type of the proceeds source is the first type or the second type, the controller 11 automatically determines either the previous-day deposit screen 140 or the current-day deposit screen 150 as the operation screen to be displayed on the operation/display unit 13 during the depositing operation. For example, the controller 11 displays the previous-day deposit screen 140 when the type of the proceeds source is the first register 20A installed in the tenant store, and displays the current-day deposit screen 150 when the type of the proceeds source is the automatic vending machine 25.

On the other hand, if the depositing process is accepted when the depositing mode is the second mode, the controller 11 of the depositing machine 10 displays the current-day deposit screen 150 on the operation/display unit 13 regardless of the type of the proceeds source.

Thus, according to the system 1, the deposit operator for proceeds in the tenant store and the deposit operator for proceeds in the automatic vending machine 25 are allowed to perform depositing through an easy-to-understand operation for both the operators.

As described above, the depositing machine 10 is an example of a valuable medium handling apparatus for depositing proceeds from sales of commodities or provision of services by a proceeds source, and includes an acquisition unit 114 that acquires the type of the proceeds source (an example of the type of a deposit source, e.g., the first type), and a determination unit 117 that determines the handling date of the proceeds to be deposited, according to the type (e.g., the first type) of the proceeds source acquired by the acquisition unit 114.

As for the depositing machine 10 configured as described above, since the depositing machine 10 determines the proceeds handling date, it is not necessary to cause the deposit operator to select the proceeds handling date. Therefore, an operation screen according to the type of the source of the proceeds to be deposited by the deposit operator can be displayed. As a result, the deposit operator can perform the depositing through an easy-to-understand operation, compared to the case where the same operation screen is displayed regardless of the type of the proceeds source.

In the flowchart described with reference to FIG. 10, when the IC card reader/writer 17 is touched with the register card or the register number is inputted, the register number stored in the register card or the inputted register number is used as identification information of the proceeds source, and the type of the proceeds source associated with the identification information of the proceeds source is acquired from the server 30. However, the present invention is not particularly limited to this configuration. For example, when a user card (e.g., employee card) in which a user ID for identifying a user (e.g., the deposit operator) is stored is held up to the IC card reader/writer 17, the depositing machine 10 may acquire the user ID from the user card, acquire, from the server 30, identification information of the proceeds source associated with the user ID and the type of the proceeds source associated with the identification information of the proceeds source, and acquire the type of the proceeds source by using the user ID. Alternatively, when a store card in which a store ID for identifying a store is stored is held up to the IC card reader/writer 17, the depositing machine 10 may acquire, from the server 30, identification information of the proceeds source associated with the store ID and the type of the proceeds source associated with the identification information of the proceeds source, and acquire the type of the proceeds source by using the store ID. Thus, the determination unit 117 determines the handling date of the proceeds to be deposited, according to the type of the proceeds source, the type of the user, and the type of the store, which are examples of deposit sources acquired by the acquisition unit 114.

The depositing machine 10 further includes the acceptance unit 113 that accepts the depositing operation for storing the proceeds. Then, the determination unit 117 determines the handling date of the proceeds to be deposited by the depositing operation accepted by the acceptance unit 113. If the depositing operation is started during a predetermined period (e.g., a period that allows the handling date to be the previous day and the current day (e.g., a period in which the depositing mode is the first mode)), the determination unit 117 determines the handling date according to the type of the proceeds source acquired by the acquisition unit 114.

Therefore, when the deposit operator performs the depositing operation, the depositing machine 10 need not cause the deposit operator to select the proceeds handling date, and therefore, need not cause the operation/display unit 13 to display the selection screen 160 shown in FIG. 8, for example. Therefore, for the deposit operator who is not accustomed to the depositing operation, the screen for depositing, such as the previous-day deposit screen 140 shown in FIG. 7A or the current-day deposit screen 150 shown in FIG. 7B, can be displayed without displaying the selection screen 160 shown in FIG. 8, for example. As a result, it is possible to avoid a situation that the deposit operator who is not accustomed to the depositing operation is confused by the input operation and cannot efficiently perform depositing, and a situation that the unaccustomed deposit operator performs erroneous depositing and an ex-post-countermeasure is required.

In the present embodiment, the determination unit 117 determines that the proceeds handling date is the previous day if the type of the proceeds source is the predetermined first type, and determines that the proceeds handling date is the current day if the type of the proceeds source is the second type different from the first type. Therefore, the determination unit 117 can quickly determine the proceeds handling date according to the type of the proceeds source. The “previous day” and the “current day” determined by the determination unit 117 are merely examples, and the determination unit 117 may determine that the proceeds handling date is the “next day”, for example. In addition, the determination unit 117 may determine that the proceeds handling data is the “previous business day” instead of the “previous day”, or the “next business day” instead of the “next day”.

The depositing machine 10 further includes the display control unit 118 that displays the selection screen 160 as to whether the proceeds handling date is the previous day or the current day. When the type of the proceeds source is the third type different from the first type and the second type, the determination unit 117 determines, as the proceeds handling date, a date selected through the selection screen 160 from the previous day and the current day. This allows, for example, the deposit operator who is accustomed to the depositing operation to select as to whether the proceeds handling date is the previous day or the current day, thereby enhancing the convenience.

Even when the type of the proceeds source is the first type, if the depositing operation is started during a period (e.g., a period when the depositing mode is the second mode) different from a predetermined period (e.g., a period when the depositing mode is the first mode) in which the handling date can be set to the previous day and the current day, the determination unit 117 determines that the handling date is the current day. Therefore, the determination unit 117 can rapidly determine the proceeds handling date according to the starting time of the depositing operation.

Moreover, the aforementioned process performed by the depositing machine 10 can be implemented through cooperation between software and hardware resources. In this case, the CPU of the controller 11 of the depositing machine 10 executes a program that implements the functions of the device, thereby implementing the functions. For example, a non-transitory computer-readable storage medium having the program stored therein is provided to the depositing machine 10, and the CPU of the depositing machine 10 reads out the program stored in the storage medium. Alternatively, the CPU of the depositing machine 10 downloads the program via the network 40. In these cases, the program read out from the storage medium or the downloaded program implements the aforementioned functions of the embodiment, and the program itself and the storage medium having the program stored therein constitute the present invention.

The program implementing the functions of the depositing machine 10 causes the computer to execute: an acquisition function of acquiring the type of a proceeds source (e.g., the first register 20A); and a determination function of determining the handling date of the proceeds from sales of commodities or provision of services by the proceeds source according to the type of the proceeds source acquired by the acquisition function.

A valuable medium handling method performed by the depositing machine 10 is a method including: acquiring a type of a deposit source; and determining a handling date of proceeds obtained from sales of commodities or provision of services, according to the type of the deposit source acquired by the acquisition function.

In the aforementioned system 1, the controller 11 of the depositing machine 10 may acquire, through the server 30, the total proceeds in the proceeds source (e.g., the first register 20A) of the proceeds to be deposited by the deposit operator, and when the acquired total proceeds is different from the deposited total proceeds, the controller 11 may announce this fact. The mode of announcement is not particularly limited. The controller 11 of the depositing machine 10 may display the acquired total proceeds and a difference between the acquired total proceeds and the deposited total proceeds, on the confirmation screen 170 or the reflection screen 180 as shown in FIG. 9A or FIG. 9B. If the difference between the acquired total proceeds and the deposited total proceeds is not 0, the controller 11 of the depositing machine 10 may notify the fact that the difference is not 0, to a person in charge of the proceeds source (e.g., the first register 20A) or the store (e.g., the tenant store) where the proceeds source is installed, via the server 30.

In the aforementioned system 1, the type of the automatic vending machine 25 is the second type. However, among automatic vending machines 25, only the type of automatic vending machines 25 owned by other companies may be the second type, and the type of automatic vending machines 25 owned by the company-operated stores may be the third type.

Furthermore, in the aforementioned system 1, the relationship between the proceeds sources, the identification information, and the types, and the relationship between the types of the proceeds sources and the proceeds handling dates, which are stored in the memory 32 of the server 30, may be stored in the memory 12 of the depositing machine 10, and the controller 11 of the depositing machine 10 may acquire the types of the proceeds sources and the proceeds handling dates from the memory 12.

Moreover, in the aforementioned system 1, even when the type of the proceeds source is the first type (in other words, the first register 20A installed in the tenant store), when the controller 11 of the depositing machine 10 has grasped, via the server 30, that the proceeds fully collected from the first register 20A are deposited, the controller 11 may set the proceeds handling date to the current day, and may cause the operation/display unit 13 to display the current-day deposit screen 150.

The present disclosure is a valuable medium handling apparatus for depositing proceeds obtained from sales of commodities or provision of services by a deposit source, and includes: an acquisition unit configured to acquire a type of the deposit source; and a determination unit configured to determine a handling date of proceeds to be deposited, according to the type of the deposit source acquired by the acquisition unit.

The acquisition unit may acquire a type of a proceeds source as the type of the deposit source.

The acquisition unit may acquire a type of a user of the valuable medium handling apparatus as the type of the deposit source.

The valuable medium handling apparatus may further include an acceptance unit configured to accept a depositing operation for storing the proceeds. The determination unit may determine the handling date of proceeds deposited by the depositing operation accepted by the acceptance unit, and when the depositing operation is started during a predetermined period, may determine the handling date according to the type of the deposit source acquired by the acquisition unit.

The determination unit may determine that the handling date is the previous day if the type of the deposit source is a predetermined first type, and may determine that the handling date is the current day if the type of the deposit source is a second type different from the first type.

The valuable medium handling apparatus may further include a display control unit configured to display a selection screen as to whether the handling date is the previous day or the current day. When the type of the deposit source is a third type different from the first type and the second type, the determination unit may determine, as the handling date, a date selected through the selection screen from the previous day and the current day.

Even if the type of the deposit source is the first type, when the depositing operation is started during a period different from the predetermined period, the determination unit may determine that the handling date is the current day.

What is claimed is:

1. A valuable medium handling apparatus for depositing proceeds obtained from sales of commodities or provision of services by a deposit source, comprising:
an acquisition unit that acquires a type of the deposit source; and
a determination unit that determines a handling date of proceeds to be deposited, according to the type of the deposit source acquired by the acquisition unit.

2. The valuable medium handling apparatus according to claim 1, wherein
the acquisition unit acquires a type of a proceeds source as the type of the deposit source.

3. The valuable medium handling apparatus according to claim 1, wherein
the acquisition unit acquires a type of a user of the valuable medium handling apparatus as the type of the deposit source.

4. The valuable medium handling apparatus according to claim 1, further comprising an acceptance unit that accepts a depositing operation for storing the proceeds, wherein
the determination unit determines the handling date of proceeds deposited by the depositing operation accepted by the acceptance unit, and when the depositing operation is started during a predetermined period, determines the handling date according to the type of the deposit source acquired by the acquisition unit.

5. The valuable medium handling apparatus according to claim 4, wherein
the determination unit determines that the handling date is the previous day if the type of the deposit source is a predetermined first type, and determines that the handling date is the current day if the type of the deposit source is a second type different from the first type.

6. The valuable medium handling apparatus according to claim 5, further comprising a display control unit that displays a selection screen as to whether the handling date is the previous day or the current day, wherein
when the type of the deposit source is a third type different from the first type and the second type, the determination unit determines, as the handling date, a date selected through the selection screen from the previous day and the current day.

7. The valuable medium handling apparatus according to claim 5, wherein
even if the type of the deposit source is the first type, when the depositing operation is started during a period different from the predetermined period, the determination unit determines that the handling date is the current day.

8. A valuable medium handling apparatus for depositing proceeds obtained from sales of commodities or provision of services by a deposit source, comprising:
an acquisition unit that acquires a predetermined time at which closing and totalization are performed and a depositing operation time; and
a determination unit that determines a handling date of proceeds to be deposited, based on the predetermined time and the depositing operation time.

9. A valuable medium handling method comprising:
acquiring a type of a deposit source; and
determining a handling date of proceeds obtained from sales of commodities or provision of services, according to the type of the deposit source acquired.

10. The valuable medium handling apparatus according to claim 2, wherein
the type of the proceeds source includes at least a register and an automatic vending machine.

11. The valuable medium handling apparatus according to claim 2, wherein
the type of the proceeds source includes at least a device installed in a tenant store and a device installed in a company-operated store.

12. The valuable medium handling apparatus according to claim 8, further includes:
a setting unit that sets a depositing mode according to time periods; wherein
the setting unit sets the depositing mode in a time period based on whether the time period is before or after the predetermined time.

13. The valuable medium handling apparatus according to claim 12, wherein
the determination unit determines a handling date of proceeds to be deposited, according to the depositing mode at the depositing operation time.
